(19) United States
(12) Patent Application Publication
(10) Pub. No.: US 2026/0119137 A1
(43) Pub. Date: Apr. 30, 2026

(54) Method and Device for Memory Scheduling for Code Generation for a Program Code for Computing an Artificial Neural Network in a Hardware Environment

(71) Applicant: Robert Bosch GmbH, Stuttgart (DE)

(72) Inventors: Sebastian Boblest, Duernau (DE); Benjamin Wagner, Friedrichshafen (DE); Duy Khoi Vo, Waiblingen (DE); Leif Sulaiman, Lund (SE); Markus Lochmann, Reutlingen (DE); Ulrik Hjort, Malmö (SE)

(21) Appl. No.: 19/366,004

(22) Filed: Oct. 22, 2025

(30) Foreign Application Priority Data
Oct. 24, 2024 (DE) 10 2024 210 285.7

(51) Int. Cl. G06F 8/35; G06F 9/38

(52) U.S. Cl. CPC G06F 8/35; G06F 9/383

(57) ABSTRACT

A computer-implemented method for performing memory scheduling for code generation to determine a code for computing a neural network in a hardware environment includes (i) providing successive computation steps of the neural network, wherein a plurality of the computation steps provide for the computation of a weight prefetching layer for which weight prefetching is applicable, (ii) assigning possible weight prefetching to at least a portion of the plurality of weight-prefetching layers in order to obtain multiple different combinations of weight-prefetching layers, wherein the weight prefetching provides for preloading of network parameters into a working memory of the hardware environment for the respective weight-prefetching layer, (iii) performing memory scheduling for the code to be generated for the plurality of different combinations, wherein the respective memory scheduling is carried out for the successive computation steps of the neural network while taking into account the respective combination of weight-prefetching layers for which weight prefetching is provided, wherein for each memory scheduling, for every computation step, the memory region of the respective input data block, output data block, and at least one network parameter block in the working memory is defined, and a maximum required memory space of the working memory is ascertained, and (iv) selecting one of the memory schedulings depending on the maximum required memory space of the working memory.

This application claims priority under 35 U.S.C. § 119 to application no. DE 10 2024 210 285.7, filed on Oct. 24, 2024 in Germany, the disclosure of which is incorporated herein by reference in its entirety.

The disclosure relates to the implementation of program code on a hardware environment, such as, for example, microcontroller-based control units and similar systems. The disclosure further relates to methods for memory scheduling for handling input data, output data and network parameters.

### BACKGROUND

Certain hardware environments, such as microcontrollers in control devices, require the creation of an adapted executable program code to take into account the characteristics and limitations of the specific hardware environment. In particular, the available memory size of the working memory that the microcontroller may directly access may be limited, or memory transfer or copy operations from a flash or external memory to the working memory may be particularly complex due to hardware constraints.

The computational steps for computing the corresponding layers of neural networks may require substantial memory resources, as for each computational layer at least one input data block and at least one output data block must be stored in the working memory so as to be accessible and usable by the microcontroller.

During memory scheduling, existing code generators determine the region of the working memory in which the data blocks required per computational layer are stored. In the course of memory scheduling, in addition to assigning the input and output data blocks to memory regions, a corresponding memory region is also allocated to the data generated in a computation layer during computation.

Weight prefetching is a technique for accelerating the computation of specific layers in neural networks. The characteristic property of these layers is that each element of the trained parameters is applied not only to one element of the input data, but to multiple layers. In many cases, fully connected layers correspond to a simple matrix multiplication. An N-dimensional input vector is multiplied by an M×N weighting matrix to generate an M-dimensional output vector. In these cases, weight prefetching is not useful, as each element of the weighting matrix is used only once. In other cases, the input data corresponds to a P×N-dimensional matrix, from which, by multiplication with and N×M matrix, a P×M matrix is generated. In this case, each element of the N×M matrix is used P times, and weight prefetching is useful. Layers that satisfy this condition include, in particular, convolution and depthwise convolution layers, as well as LSTM and fully connected layers when applied to a series of data (weight-prefetching layers).

In particular, weight prefetching is useful on systems without a cache. This takes advantage of the fact that, for example, each element in the kernel for computing a convolution of the convolutional layer is used many times during the computation.

ETAS GmbH's Embedded AI Coder code generator uses weight prefetching to accelerate neural networks containing the layers listed above.

Typically, the trained network parameters of a layer are stored in the data memory, e.g., a flash memory, of the hardware environment, and then loaded into the registers when they are required for computation. When weight prefetching is employed, all network parameters, i.e., the kernel, bias, and quantization parameters of quantized neural networks, are copied from the data memory to the working memory prior to the start of computation of the respective layer. All subsequent fetch operations then obtain data from the working memory rather than from the data memory, which is considerably faster.

Upon completion of the computation of the respective layer, the memory used for the network parameters of the respective layer may be reused for other data.

However, the additional consumption of working memory due to the preloading of the network parameters during weight prefetching may significantly increase the amount of maximum memory required in the working memory.

Very often, however, the increase in the maximum required working memory is only caused by one or a few layers in the neural network, while working memory remains unused when computing other layers with weight prefetching. Weight prefetching on these layers has no negative effect on the amount of maximum working memory required.

It is an object of the present disclosure to provide improved memory management for faster computation of artificial neural networks, where the maximum amount of working memory required remains limited.

### SUMMARY

This object is achieved by the method for performing memory scheduling for code generation of a code for computing a neural network according to the description set forth below, as well as by the device also according to the description set forth below.

Further embodiments are specified in the following description.

According to a first aspect, there is provided a computer-implemented method for performing code generation memory scheduling to determine a code for computing a neural network in a hardware environment, comprising the steps of:
providing successive computational steps of the neural network, wherein a plurality of the computational steps provide computation of a weight prefetching layer for which weight prefetching is applicable;
assigning a possible weight prefetching to at least a portion of the plurality of weight prefetching layers to obtain a plurality of different combinations of weight prefetching layers, wherein the weight prefetching provides for preloading network parameters into a working memory of the hardware environment for the respective weight prefetching layer;
performing memory scheduling for the code to be generated for the plurality of different combinations, wherein the respective memory scheduling for the successive computation steps of the neural network is performed taking into account the respective combination of the weight prefetching layers for which weight prefetching is provided, wherein for the respective memory scheduling for each computation step the memory region of the respective input data block, output data block and at least one network parameter block in the working memory is determined and a maximum required memory space of the working memory is ascertained;
selecting one of the memory schedulings depending on the maximum memory space of the working memory required.

The individual computation steps for computing the computation layers of a neural network are usually computed serially on a hardware environment. This means that the generated code for the hardware environment defines a sequence in which the input data is processed and the output data of the respective computation step is generated. Each computation step takes the input data from one or more input data blocks in the working memory and stores the resulting output data in one or more output data blocks in the working memory. Input data blocks and output data blocks represent memory regions of the working memory that correspond to a contiguous address space. In addition, network parameters for the computation of the individual computation steps (layers) may be temporarily stored in the working memory in order to obtain quick access to the network parameters.

Weight prefetching is an optimization technique used in the implementation of neural networks to improve the efficiency and speed of the computation steps. Required network parameters are loaded from a data memory (which may not be accessed during the computation step) into the working memory in good time before they are actually required.

Prefetching may reduce the latency times that would result from loading the weights and use the computing power more efficiently. Weight prefetching is particularly applicable for the computation of layers/computation steps of the neural network that repeatedly access the network parameters. In particular, layers that fulfill this requirement are convolutional and depthwise convolutional layers, but also LSTM and fully connected layers if they are applied to a range of data (weight prefetching layers).

Memory scheduling determines the memory regions in the working memory where the respective input data blocks and output data blocks are to be allocated before code is generated to perform the computation steps. If weight prefetching is provided for a computation step, the allocation of a respective network parameter block or several network parameter blocks for storing the network parameters is also taken into account in the storage planning.

By carrying out a plurality of memory schedulings for the computation of neural networks with weight prefetching layers, for which weight prefetching is provided in different combinations, a respective maximum required memory space in the working memory may be ascertained. This enables a well-founded selection of the combination of weight prefetching layers for which weight prefetching is intended, in which the combination of the increase in the maximum memory space required, which is negative for the user, and the faster execution time, which is positive for the user, is optimal for the respective application.

The memory scheduling may provide for first ascertaining the maximum required memory space in an implementation of a neural network (sequence of computation steps) for which no weight prefetching is provided. Since each weight prefetching leads to an acceleration of the computation steps, weight prefetching may now be provided for that combination of weight-prefetching layers for which the memory scheduling results in no increase of the maximum required memory space compared to the maximum required memory space in an implementation of a neural network (sequence of computation steps) without weight prefetching. This implementation is therefore faster than the original implementation without weight prefetching, while the maximum required working memory remains the same, and is thus objectively superior.

Alternatively, weight prefetching may be provided for that combination of weight-prefetching layers in which the memory scheduling results in an increase of the maximum required memory space, compared to the maximum required memory space in an implementation of a neural network (sequence of computation steps) without weight prefetching, of less than a predetermined relative proportion, while at the same time the number of weight-prefetching layers for which weight prefetching is provided is maximal.

Furthermore, a Pareto curve of combinations of weight-prefetching layers for which weight prefetching is provided may be generated, which indicates the smallest maximum required memory space with respect to the shortest computation time for the computation of all computation steps. This enables an improved selection of the combination of weight-prefetching layers for which weight prefetching is provided.

The Pareto curve offers the advantage that it enables the selection of an implementation with the best possible compromise between the maximum required memory space and the computation time for the computation of all computation steps.

The above methods may be combined very effectively with the tiling method to reduce the required working memory for the computation of a convolutional neural network, wherein, according to a tiling factor, the computation steps for a sequence of layers for which tiling may be applied may be divided into several tiling computation steps, for each of which weight prefetching may or may not be provided according to the combinations provided. This increases the number of combinations/possibilities to apply weight prefetching selectively for the computation steps of a neural network.

It may thus also be provided that the combinations of weight-prefetching layers further take into account tiling computation steps when tiling is provided for tiling-suitable weight-prefetching layers, in particular, for convolution layers, depthwise convolution layers, pooling layers, and all element-wise operating layers, with a plurality of possible tiling factors, such that for each combination of weight-prefetching layers and sequences of tiling computation steps determined by the tiling factor, for which weight prefetching is provided, a memory scheduling is carried out and a maximum required memory space of the working memory is ascertained.

In other words, combinations of non-tiled weight prefetching layers to which weight prefetching is or is not assigned and tiling computation steps for weight prefetching layers tiled with a certain tiling factor are created, wherein the tiling computation steps are each assigned weight prefetching or not. The combinations also take into account multiple tiling factors for the weight-prefetching layers subjected to tiling with a given tiling factor.

In particular, performing the memory scheduling may include the application of an optimization procedure in which the objective function takes into account a minimization of the maximum required memory space.

The memory scheduling may be carried out, in a manner known per se, using a so-called SMT solver. This begins with a list of successive computation steps that define the neural network, along with associated memory regions of the input data blocks, network parameter blocks, and output data blocks that have not yet been assigned to an address region in the working memory.

### BRIEF DESCRIPTION OF THE DRAWINGS

Embodiments are explained in more detail below with reference to the accompanying drawings. It shows:

FIG. 1 a schematic representation of a platform for code generation and implementation in a hardware environment

FIG. 2 a schematic flow chart illustrating a memory scheduling method for determining weight prefetching layers for which weight prefetching is provided

FIG. 3 an exemplary Pareto curve of combinations of weight-prefetching layers subjected to weight prefetching

FIG. 4 a structure of a convolutional neural network with 9 convolutional layers.

### DETAILED DESCRIPTION

FIG. 1 shows a block diagram of a platform 1 for carrying out code generation and implementing generated program code in a hardware environment 2. For example, the hardware environment corresponds to a control unit with a microcontroller, microprocessor or similar. The code generation is carried out on a conventional computer (3) or workstation based on a predefined configuration of a neural network. The computer (3) is configured to perform memory scheduling and code generation, wherein the memory scheduling first allocates memory regions for storing at least one input data block and at least one output data block for the individual computation steps of the neural network. The network parameter block or the plurality of network parameter blocks comprise all network parameters that are required for the computation of the respective computational step, e.g., kernel values, weightings, and bias values of a convolutional layer.

Once the code has been generated, it is transferred to the hardware environment 2 and implemented or executed there.

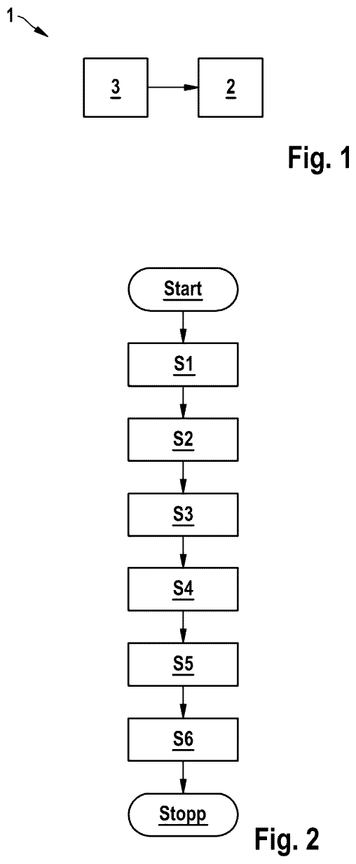

FIG. 2 schematically illustrates the sequence of a memory scheduling process using an SMT solver.

In step S1, successive computation steps for computing a neural network are initially specified, to each of which at least one input data block and at least one output data block are assigned as memory regions in the working memory with defined variables.

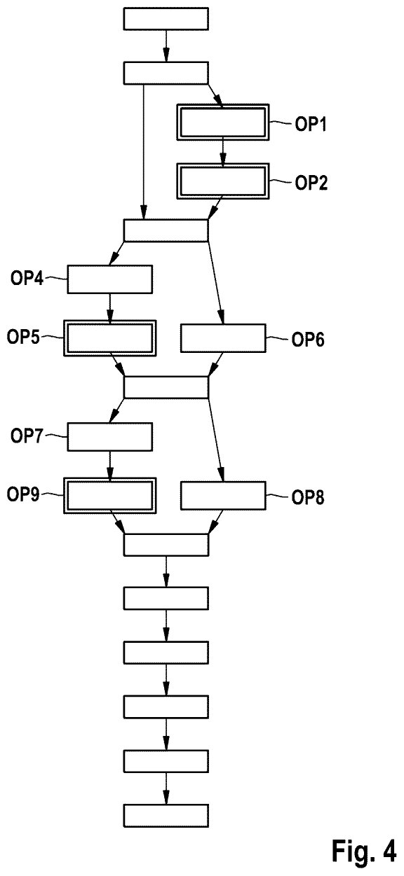

As an example, FIG. 4 shows a sequence of computation steps for an exemplary neural network in which 9 convolutional layers Op1-Op9 are computed. The individual computation steps for computing the computation layers of a neural network are generally executed serially on a hardware environment according to a generated code. This means that the generated code for the hardware environment defines a sequence in which the input data is processed and the output data of the respective computation step is generated. Each computation step takes the input data from one or more input data blocks in the working memory and stores the resulting output data in one or more output data blocks in the working memory. Input data blocks and output data blocks represent memory regions of the working memory that correspond to a contiguous address space. In addition, network parameters for the computation of the individual computation steps (layers) may be temporarily stored in the working memory in order to obtain quick access to the network parameters.

In step S2, computational steps for computing weight prefetching layers are identified. In principle, the computation of the weight prefetching layers is suitable for weight prefetching in which network parameters are preloaded into a network parameter block or a plurality of network blocks, each representing a memory region in the working memory.

In step S3, a weight prefetching is assigned or not to each of the weight prefetching layers for a plurality of combinations. The combinations specify which of the weight prefetching layers are to be taken into account in the memory scheduling with weight prefetching and which are not.

In step S4, memory scheduling is carried out for each of the combinations, wherein the respective memory scheduling for the successive computation steps of the neural network is carried out taking into account the respective combination of the weight prefetching layers for which weight prefetching is provided. For this purpose, a network parameter block or several network parameter blocks are reserved in a memory region of the working memory for each of the weight prefetching layers for which weight prefetching is intended. Memory scheduling may be carried out with a so-called SMT solver, which basically pursues the optimization goal of minimizing the maximum memory space required in the working memory. At the same time, the required computation time may also be determined from the memory schedulings, such that a Pareto curve of minimal maximum required memory space and the resulting computation time may be established.

In step S5, a corresponding combination may then be selected from the combinations for which memory scheduling has been carried out and this may be taken into account in step S6 during code generation.

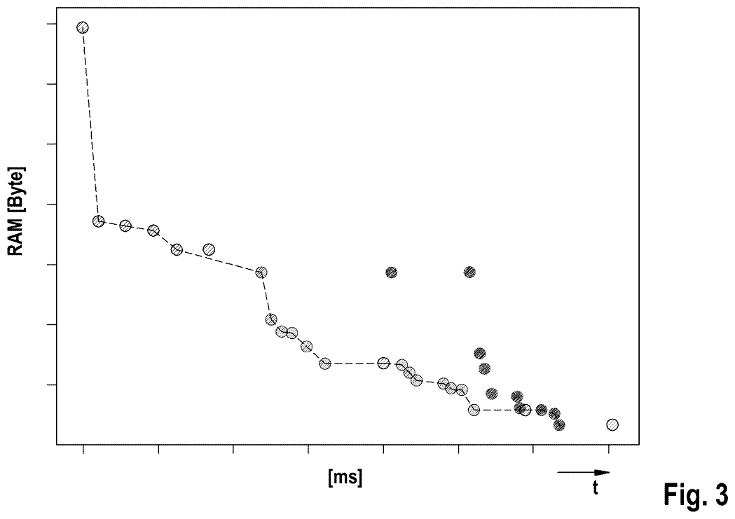

FIG. 3 shows an example of such a Pareto curve, where the points show possible combinations of weight prefetching layers and are each determined by their computation duration/running time and maximum required storage space.

The above methods may be very effectively combined with a tiling method for computing a convolutional neural network, wherein, according to a tiling factor, one or more computation steps for computing a convolutional layer may be divided into several tiling computation steps, for each of which weight prefetching may or may not be provided according to the provided combinations. This increases the possibilities of using weight prefetching selectively for the computation steps of a neural network. In addition to deciding for which weight prefetching layers weight prefetching should be used, the above procedure also makes it possible to determine which tiling factor should preferably be selected for a particular convolutional layer.

What is claimed is:

1. A computer-implemented method for performing memory scheduling for code generation to determine a code for computing a neural network in a hardware environment, comprising:
providing successive computation steps of the neural network, wherein a plurality of the computation steps provide for the computation of a weight prefetching layer for which weight prefetching is applicable;
assigning possible weight prefetching to at least a portion of the plurality of weight-prefetching layers in order to obtain multiple different combinations of weight-prefetching layers, wherein the weight prefetching provides for preloading of network parameters into a working memory of the hardware environment for the respective weight-prefetching layer;
performing memory scheduling for the code to be generated for the plurality of different combinations, wherein the respective memory scheduling is carried out for the successive computation steps of the neural network while taking into account the respective combination of weight-prefetching layers for which weight prefetching is provided, wherein for each memory scheduling, for every computation step, the memory region of the respective input data block, output data block, and at least one network parameter block in the working memory is defined, and a maximum required memory space of the working memory is ascertained; and
selecting one of the memory schedulings depending on the maximum required memory space of the working memory.

2. The method according to claim 1, wherein performing the memory scheduling includes applying an optimization method in which the objective function takes into account minimization of the maximum required memory space in the working memory.

3. The method according to claim 1, wherein the selection of the memory scheduling is additionally carried out depending on a number of weight-prefetching layers for which weight prefetching is provided, wherein, in particular, that memory scheduling for which the number of weight-prefetching layers for which weight prefetching is provided is maximal, is selected.

4. The method according to claim 1, wherein the memory scheduling of that combination of weight-prefetching layers is selected in which, during memory scheduling, an increase in the maximum required memory space compared to the maximum required memory space in an implementation of a neural network without weight prefetching amounts to less than a predetermined relative proportion, and at the same time the number of weight-prefetching layers for which weight prefetching is provided is maximal.

5. The method according to claim 1, wherein the memory scheduling of that combination of weight-prefetching layers is selected from those combinations of weight-prefetching layers that lie on a Pareto curve of combinations of weight-prefetching layers for which weight prefetching is provided, wherein the Pareto curve indicates the lowest maximum required memory space with respect to a correspondingly shortest computation time for the computation of all computation steps.

6. The method according to claim 1, wherein the combinations of weight-prefetching layers further take into account tiling computation steps when tiling is provided for weight-prefetching layers suitable for tiling, in particular, for convolution layers, depthwise convolution layers, pooling layers, and all element-wise operating layers, with a plurality of possible tiling factors, such that for each combination of weight-prefetching layers and sequences of tiling computation steps determined by the tiling factor, for which weight prefetching is provided, a memory scheduling is carried out and a maximum required memory space of the working memory is determined.

7. The method according to claim 1, wherein code generation for the hardware environment is performed based on the selected memory scheduling and the generated code is implemented therein.

8. A device for carrying out the method according to claim 1.

9. A computer program product comprising instructions which, when the program is executed by at least one data processing unit, cause said unit to carry out the steps of the method according to claim 1.

10. A machine-readable storage medium comprising instructions which, when executed by at least one data processing unit, cause the data processing unit to perform the steps of the method according to claim 1.
